(19) United States
(12) Patent Application Publication
(10) Pub. No.: US 2011/0311848 A1
(43) Pub. Date: Dec. 22, 2011

(54) BATTERY MODULE HAVING A SEALED VENT CHAMBER

(76) Inventors: Michael P. Garascia, Waterford, MI (US); Anthony P. Arena, Macomb Twp., MI (US); Steve Esshaki, Royal Oak, MI (US)

(21) Appl. No.: 13/168,740

(22) Filed: Jun. 24, 2011

Related U.S. Application Data
(63) Continuation of application No. PCT/US2010/028910, filed on Mar. 26, 2010.
(60) Provisional application No. 61/164,308, filed on Mar. 27, 2009.

(51) Int. Cl. H01M 2/12; H01M 2/08; H01M 10/04; H01M 2/10

(52) U.S. Cl. 429/87; 29/623.1

(57) ABSTRACT

A battery module includes a plurality of electrochemical cells each comprising a vent at one end of the cell configured to allow gas to escape from within the cell. The battery module also includes a structure configured to receive the plurality of electrochemical cells so that the vent of each electrochemical cell is in fluid communication with a chamber within the structure. The structure includes a first portion having a protrusion provided along an outer edge thereof and a second portion having a groove provided along an outer edge thereof. The groove is configured to receive the protrusion of the first portion to seal gas released from any of the electrochemical cells within the chamber.

### CROSS-REFERENCE TO RELATED PATENT APPLICATIONS

This application is a continuation of International Patent Application No. PCT/US2010/028910, filed Mar. 26, 2010, which claims the benefit of and priority to U.S. Provisional Patent Application No. 61/164,308, filed Mar. 27, 2009. The entire disclosures of International Patent Application No. PCT/US2010/028910, and U.S. Provisional Patent Application No. 61/164,308 are incorporated herein by reference.

### BACKGROUND

The present application relates generally to the field of batteries and battery systems. More specifically, the present application relates to batteries and battery systems that may be used in vehicle applications to provide at least a portion of the motive power for the vehicle.

Vehicles using electric power for all or a portion of their motive power (e.g., electric vehicles (EVs), hybrid electric vehicles (HEVs), plug-in hybrid electric vehicles (PHEVs), and the like, collectively referred to as “electric vehicles”) may provide a number of advantages as compared to more traditional gas-powered vehicles using internal combustion engines. For example, electric vehicles may produce fewer undesirable emission products and may exhibit greater fuel efficiency as compared to vehicles using internal combustion engines (and, in some cases, such vehicles may eliminate the use of gasoline entirely, as is the case of certain types of PHEVs).

As electric vehicle technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early electric vehicle systems employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in electric vehicles. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in the electric vehicle (or, alternatively, this feature may allow manufacturers to provide a greater amount of power for the vehicle without increasing the weight of the vehicle or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It would be desirable to provide an improved battery module and/or system for use in electric vehicles that addresses one or more challenges associated with NiMH and/or lithium-ion battery systems used in such vehicles. It also would be desirable to provide a battery module and/or system that includes any one or more of the advantageous features that will be apparent from a review of the present disclosure.

### SUMMARY

According to an exemplary embodiment, a battery module includes a plurality of electrochemical cells each comprising a vent at one end of the cell configured to allow gas to escape from within the cell. The battery module also includes a structure configured to receive the plurality of electrochemical cells so that the vent of each electrochemical cell is in fluid communication with a chamber within the structure. The structure includes a first portion having a protrusion provided along an outer edge thereof and a second portion having a groove provided along an outer edge thereof. The groove is configured to receive the protrusion of the first portion to seal gas released from any of the electrochemical cells within the chamber.

According to another exemplary embodiment, a battery module includes a plurality of electrochemical cells. Each cell includes a vent at one end thereof. Each vent is configured to allow gas from within the cell to exit the cell. The battery module also includes a structure configured to receive the plurality of electrochemical cells so that the vent of each electrochemical cell is provided within a chamber defined by the structure. The structure includes a first portion having a projection provided along an outer edge thereof and a second portion having a groove provided along an outer edge thereof. The groove is configured to receive the projection of the first portion to seal the chamber such that gas released from any of the electrochemical cells remains within the chamber.

According to another exemplary embodiment, a method of producing a battery module having a sealed chamber includes providing a plurality electrochemical cells, each of the electrochemical cells including a vent at an end thereof. The method further includes providing a structure configured to receive the ends of each of the electrochemical cells. The structure includes a first portion having a protrusion located along an outer edge thereof and a second portion having a groove located along an outer edge thereof, the groove configured to receive the protrusion of the first portion. The method further includes coupling the first and second portions of the structure together to form a sealed chamber.

### BRIEF DESCRIPTION OF THE DRAWINGS

FIG. 1 is a perspective view of a vehicle including a battery system according to an exemplary embodiment.

FIG. 2 is a cutaway schematic view of a vehicle including a battery system according to an exemplary embodiment.

FIG. 3 is a perspective view of a portion of a battery module for use in a battery system according to an exemplary embodiment.

FIG. 4 is a front view of the battery module of FIG. 3.

FIG. 5 is a top view of the battery module of FIG. 3.

FIG. 6 is a side view of the battery module of FIG. 3.

FIG. 7 is a cross-sectional view of the battery module of FIG. 6 taken along line 7-7 in FIG. 6.

FIG. 8 is a detail view of a portion of the battery module of FIGS. 7 and 15 according to an exemplary embodiment.

FIG. 9 is an exploded view of the portion of the battery module shown in FIG. 8.

FIG. 10 is a detail view of a portion of a battery module according to another exemplary embodiment.

FIG. 11 is a perspective view of a portion of a battery module for use in a battery system according to another exemplary embodiment.

FIG. 12 is a front view of the battery module of FIG. 11.

FIG. 13 is a top view of the battery module of FIG. 11.

FIG. 14 is a side view of the battery module of FIG. 11.

FIG. 15 is a cross-sectional view of the battery module of FIG. 14 taken along line 15-15 in FIG. 14.

FIG. 16A is a flow chart of a method of assembling a battery module according to an exemplary embodiment.

FIG. 16B is a flow chart of a method of assembling a battery module according to another exemplary embodiment.

FIG. 17A is a detail view of a portion of the battery module of FIGS. 7 and 15 according to an exemplary embodiment.

FIG. 17B is a detail view of a portion of the battery module of FIGS. 7 and 15 according to another exemplary embodiment.

### DETAILED DESCRIPTION

FIG. 1 is a perspective view of a vehicle 10 in the form of an automobile (e.g., a car) having a battery system 20 for providing all or a portion of the motive power for the vehicle 10. Such a vehicle 10 can be an electric vehicle (EV), a hybrid electric vehicle (HEV), a plug-in hybrid electric vehicle (PHEV), or other type of vehicle using electric power for propulsion (collectively referred to as “electric vehicles”).

Although the vehicle 10 is illustrated as a car in FIG. 1, the type of vehicle may differ according to other exemplary embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

Although the battery system 20 is illustrated in FIG. 1 as being positioned in the trunk or rear of the vehicle, according to other exemplary embodiments, the location of the battery system 20 may differ. For example, the position of the battery system 20 may be selected based on the available space within a vehicle, the desired weight balance of the vehicle, the location of other components used with the battery system 20 (e.g., battery management systems, vents, or cooling devices, etc.), and a variety of other considerations.

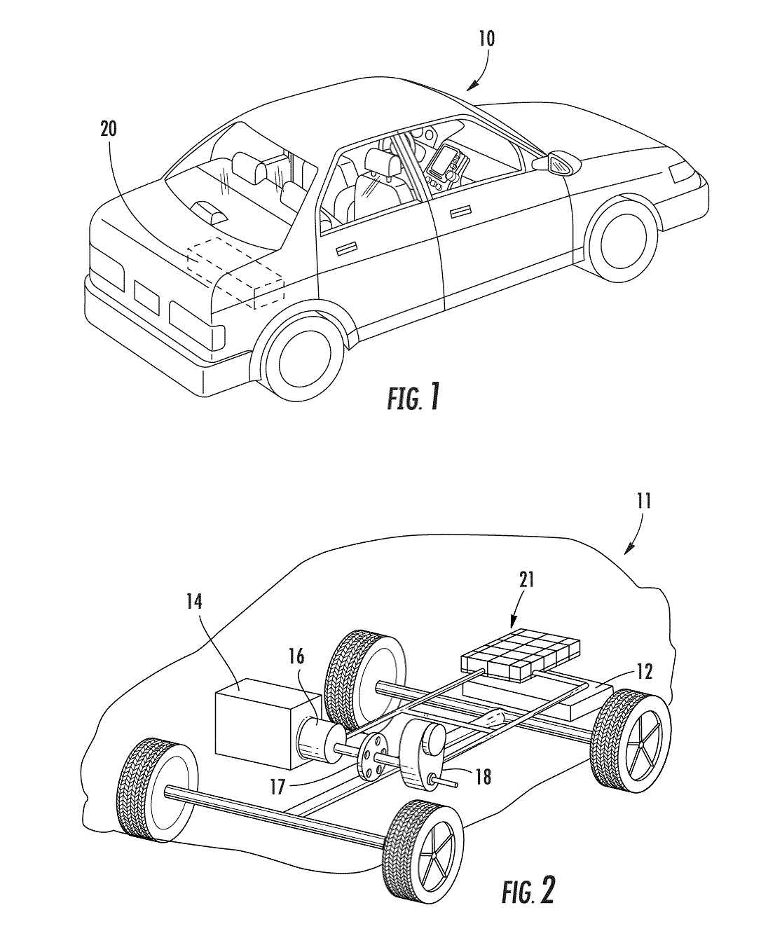

FIG. 2 illustrates a cutaway schematic view of a vehicle 11 provided in the form of an HEV according to an exemplary embodiment. A battery system 21 is provided toward the rear of the vehicle 11 proximate a fuel tank 12 (the battery system 21 may be provided immediately adjacent the fuel tank 12 or may be provided in a separate compartment in the rear of the vehicle 11 (e.g., a trunk) or may be provided elsewhere in the vehicle 11). An internal combustion engine 14 is provided for times when the vehicle 11 utilizes gasoline power to propel the vehicle 11. An electric motor 16, a power split device 17, and a generator 18 are also provided as part of the vehicle drive system.

Such a vehicle 11 may be powered or driven by just the battery system 21, by just the engine 14, or by both the battery system 21 and the engine 14. It should be noted that other types of vehicles and configurations for the vehicle drive system may be used according to other exemplary embodiments, and that the schematic illustration of FIG. 2 should not be considered to limit the scope of the subject matter described in the present application.

According to various exemplary embodiments, the size, shape, and location of the battery systems 20, 21, the type of vehicles 10, 11, the type of vehicle technology (e.g., EV, HEV, PHEV, etc.), and the battery chemistry, among other features, may differ from those shown or described.

According to an exemplary embodiment, the battery system 20, 21 is responsible for packaging or containing electrochemical batteries or cells, connecting the electrochemical cells to each other and/or to other components of the vehicle electrical system, and regulating the electrochemical cells and other features of the battery system 20, 21. For example, the battery system 20 may include features that are responsible for monitoring and controlling the electrical performance of the battery system 20, 21, managing the thermal behavior of the battery system 20, 21, containing and/or routing of effluent (e.g., gases that may be vented from a cell), and other aspects of the battery system 20, 21.

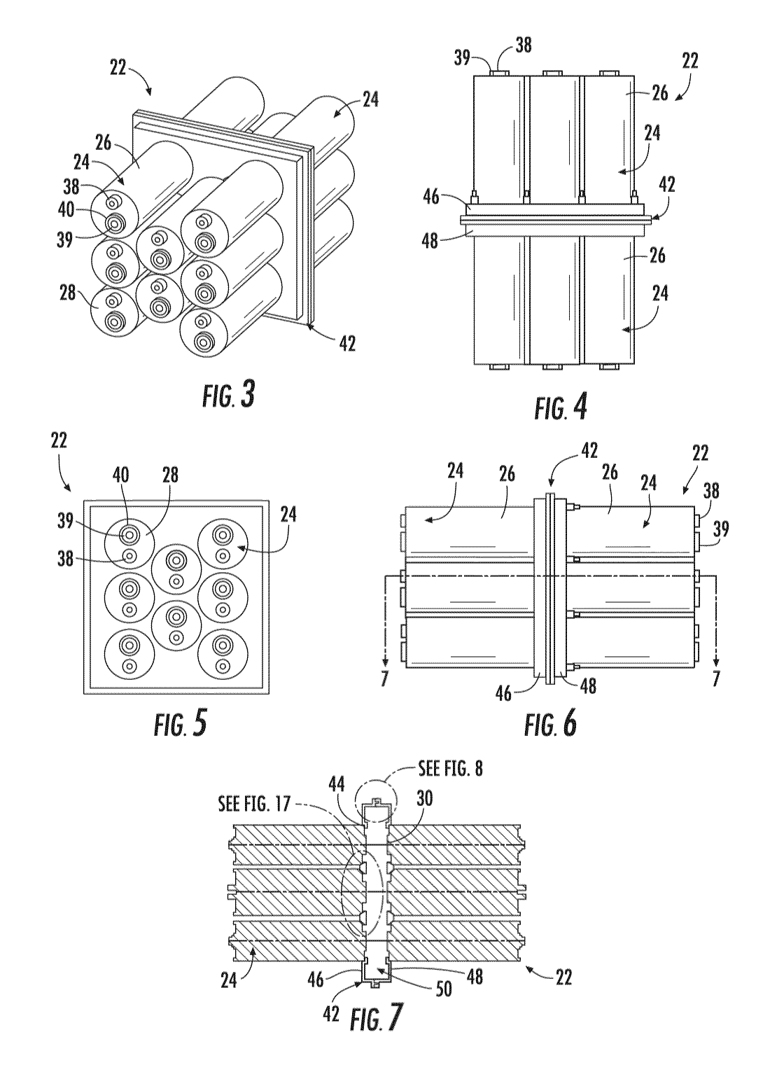

According to an exemplary embodiment, the battery system 20, 21 may include one or more battery modules 22 as shown in FIGS. 3-15. Although only a single battery module 22 is shown in each of FIGS. 3-15, a different number of battery modules 22 may be included in the battery system 20, 21, depending on the desired power and other characteristics of the battery system 20, 21. According to other exemplary embodiments, the battery modules 22 may be located in a side-by-side configuration, an end-to-end configuration, or other configuration.

Referring to FIGS. 3-15, the battery module 22 includes a plurality of electrochemical cells 24 (e.g., lithium-ion cells, lithium polymer cells, nickel-metal-hydride cells, etc., or other types of electrochemical cells now known or hereafter developed). According to an exemplary embodiment, the electrochemical cells 24 are generally cylindrical lithium-ion cells configured to store an electrical charge. According to other exemplary embodiments, the electrochemical cells 24 could have other physical configurations (e.g., oval, prismatic, polygonal, etc.). The capacity, size, design, and other features of the electrochemical cells 24 may also differ from those shown according to other exemplary embodiments.

Although illustrated in the FIGURES as having a particular number of electrochemical cells 24 (e.g., FIGS. 3-7 show two groupings of electrochemical cells arranged end-to-end, with each grouping including eight electrochemical cells, for a total of 16 electrochemical cells, while FIGS. 11-15 show one grouping of electrochemical cells, for a total of eight electrochemical cells), it should be noted that according to other exemplary embodiments, the battery module 22 may have a different number and/or arrangement of electrochemical cells 24 depending on any of a variety of considerations (e.g., the desired power for the battery module, the available space within which the battery module must fit, etc.).

As shown in FIGS. 3-7 and 11-15, each of the electrochemical cells 24 includes a housing or can 26 having a lid or cover 28 at an end of the housing 26. According to the exemplary embodiments shown in the FIGURES, each electrochemical cell 24 has a positive terminal 38 and a negative terminal 39 provided on one end of the electrochemical cell 24. As shown, according to an exemplary embodiment, the positive terminal 38 is conductively coupled to the cover 28 (and thus to the housing 26) while the negative terminal 39 is insulated from the cover 28 by an insulating member 40. According to other exemplary embodiments, other configurations of the terminals are possible (e.g., each electrochemical cell 24 may have only one terminal with the housing acting as the second terminal, the terminal(s) may be located elsewhere on the cell, etc.).

According to an exemplary embodiment, each of the electrochemical cells 24 are electrically coupled to one or more other electrochemical cells 24 or other components of the battery system 20, 21 using connectors provided in the form of bus bars or similar elements (not shown). According to an exemplary embodiment, the bus bars are constructed from a conductive material such as copper (or copper alloy), aluminum (or aluminum alloy), or other suitable material. According to an exemplary embodiment, the bus bars may be coupled to the terminals 38, 39 of the electrochemical cells 24 by welding (e.g., resistance welding) or through the use of fasteners. For example, a bolt or screw may be received in a hole at an end of the bus bar and screwed into a threaded hole in the terminal 38, 39.

Referring now to FIGS. 7 and 15, each of the electrochemical cells 24 includes a vent 30 according to an exemplary embodiment. The vent 30 (e.g., a pressure relief device or region, etc.) provides a pressure relief mechanism for the electrochemical cell 24 that allows a controlled release of pressure and gas from inside the cell 24. According to an exemplary embodiment, the vent 30 comprises a member or element (e.g., vent disk) that is configured to deploy or separate from the electrochemical cell 24 by “breaking away” from the housing 26 of the electrochemical cell 24 at a weakened area (e.g., a fracture point or groove) if the pressure inside the electrochemical cell 24 increases above a predetermined point. An example of such a vent 30 is shown and described in International Patent Application No. PCT/US2010/021193, the entire disclosure of which is incorporated by reference in its entirety. According to other exemplary embodiments, other types of vents may be used (e.g., vents that don't use a fracture point, such as, e.g., a pressure relief valve). As the vent 30 deploys, gases and/or effluent are released from inside the housing 26 of the electrochemical cell 24 into a chamber 50 (such as, e.g., shown in FIGS. 7 and 15).

Referring to FIGS. 3-7 and 11-15, according to an exemplary embodiment, a member or element in the form of a tray, housing, or similar structure 42 is provided to receive (e.g., retain, hold, constrain, position, etc.) the electrochemical cells 24. The structure 42 may be made of a polymeric material or other suitable materials (e.g., electrically insulative materials). The structure 42 may also include features to provide spacing of the electrochemical cells 24 away from the bottom surface of the structure 42 and/or from adjacent cells. For example, according to an exemplary embodiment, the structure 42 may include a series of apertures or features (e.g., such as sockets 44 as shown in FIGS. 7 and 15) configured to receive a lower end of the electrochemical cells 24. A cover or housing (not shown) may be provided to partially or completely surround or enclose the electrochemical cells 24 and the structure 42.

According to an exemplary embodiment, the sockets 44 are generally circular openings having at least one step or surface configured to engage or receive the lower portion of the electrochemical cell 24 (e.g., as shown in FIGS. 17A and 17B). According to other exemplary embodiments, the openings of the sockets 44 may have other shapes to receive cells of different shapes (e.g., prismatic, oval, etc.). The lower steps or surface of the socket 44 positions the electrochemical cell 24 such that the vent 30 is in fluid communication with an airspace or chamber 50 defined by the structure 42 (e.g., as shown in FIGS. 7 and 15). The chamber 50 is configured to receive gases and/or effluent that may be vented or released by the vent 30 of the electrochemical cells 24.

According to an exemplary embodiment, the battery module 22 may also include at least one sealing member such as a gasket or seal such as those shown and described in International Patent Application No. PCT/US2009/053697, the entire disclosure of which is incorporated by reference in its entirety. According to an exemplary embodiment, the seal is configured to aid in sealing the lower portions of the electrochemical cells 24 in the structure 42 to help retain any gases vented from the electrochemical cells 24 into the chamber 50. According to one exemplary embodiment, a single seal (such as, e.g., seal 32A shown in FIG. 17A) is provided adjacent a surface of the structure 42. According to another exemplary embodiment, individual seals (such as, e.g., seal 32B shown in FIG. 17B) may be provided in each of the sockets 44.

According to an exemplary embodiment, the seal may be constructed from a pliable, non-conductive material (e.g., such as silicone, rubber, etc.). According to one exemplary embodiment, the seal may be die cut from a silicone sheet or other suitable material. According to another exemplary embodiment, the seal may be a molded member (e.g., made by an injection molding process), such as a silicone molded member. Examples of other seals may be found in International Patent Application No. PCT/US2009/053697.

According to an exemplary embodiment, the plurality of electrochemical cells 24 are provided end-to-end in the structure 42 (e.g., such as shown in FIGS. 3-7). According to another exemplary embodiment, the electrochemical cells 24 are provided only one a first side or portion of the structure 42 (e.g., such as first portion 46 as shown in FIGS. 11-15). According to other exemplary embodiments, the plurality of electrochemical cells 24 may be provided in other configurations.

According to an exemplary embodiment, the electrochemical cells 24 are received (e.g., retained, held, constrained, positioned, etc.) by the structure 42 such that an end of the electrochemical cells 24 such that the vent 30 is in fluid communication with the airspace or chamber 50 formed by the structure 42 (see, e.g., FIGS. 7 and 15). According to an exemplary embodiment, the chamber 50 (e.g., space, plenum, cavity, hollow, compartment, etc.) is configured to receive any gases and/or effluent released from the cells 24 (e.g., via the vent 30). According to an exemplary embodiment, when the battery module 22 is provided in the cabin of a vehicle, the chamber 50 is configured to isolate these vented gases from the cabin (i.e., the vented gases do not escape from the chamber 50). According to another exemplary embodiment, the chamber 50 is configured to direct the gases to the exterior environment (e.g., outside the vehicle 10, 11) with, for example, a tube or a hose (not shown).

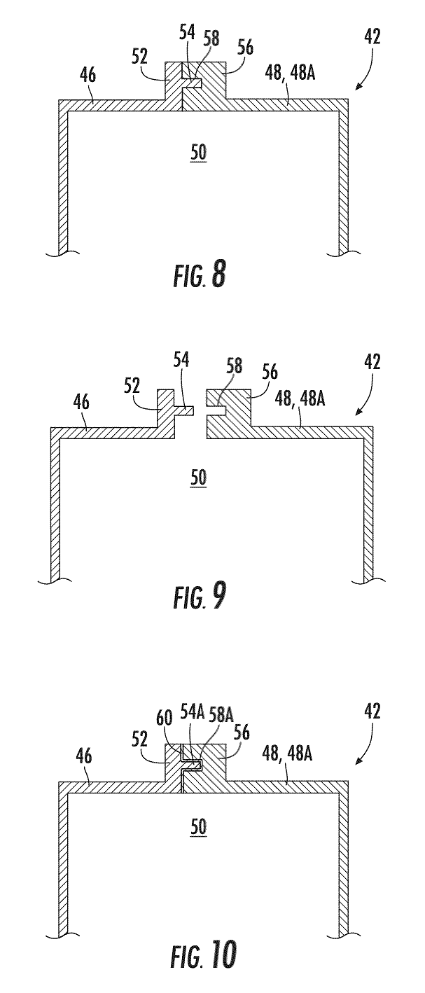

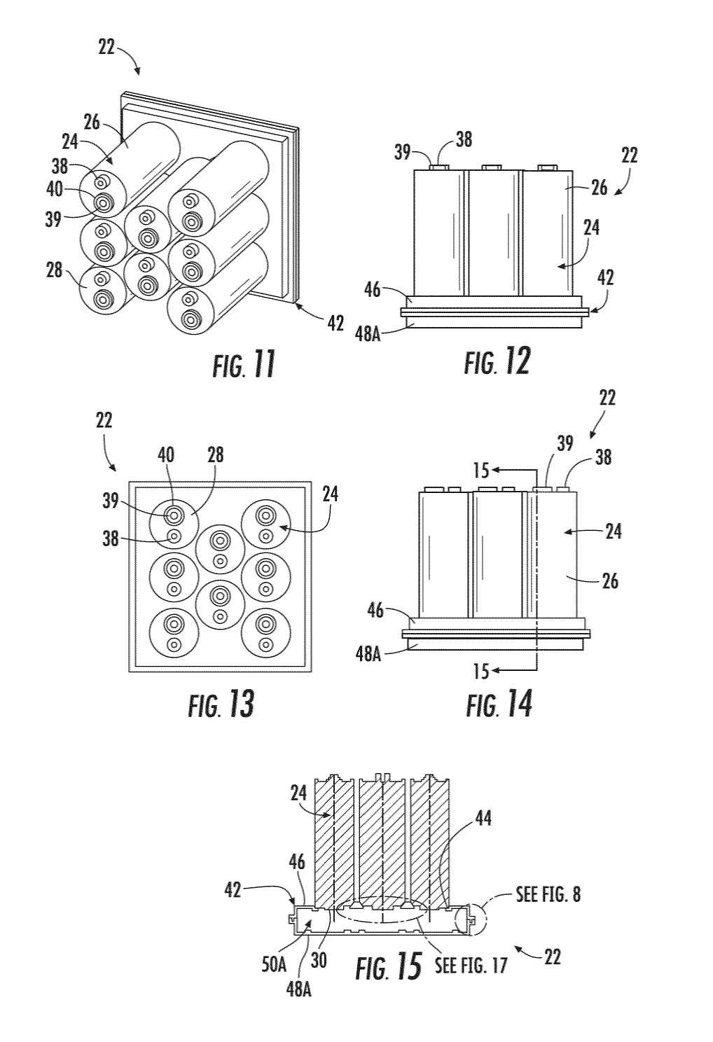

According to an exemplary embodiment, the chamber 50 may be formed by coupling together two separate members or elements of the structure 42 (e.g., first portion 46 and second portion 48, 48A) of the structure 42 (e.g., as shown in FIGS. 8-10). According to an exemplary embodiment, each portion 46, 48, 48A of the structure 42 includes an edge or edge portion configured for coupling to the corresponding edge or edge portion of the other half of the structure 42.

According to one exemplary embodiment, the edge (e.g., outer edge) of the first portion 46 of the structure 42 may include a member or flange 52 having a rib or protrusion 54 (e.g., projection, extension, ridge, protuberance, etc). Additionally, the edge (e.g., outer edge) of the second portion 48 of the structure 42 may include a member or flange 56 having a groove or channel 58 (e.g., a slot, opening, path, etc.) that is configured to receive the protrusion 54 of the first portion 46. According to another exemplary embodiment, the first portion 46 may include the groove 58 and the second portion 48 may include the protrusion 54. According to an exemplary embodiment, both the protrusion 54 and the groove 58 extend along the entire edge (i.e., along the entire perimeter) of the respective portions of the structure 42. According to other exemplary embodiments, the protrusion 54 and/or the groove 58 may extend along the only a portion of the edge of the respective portions of the structure 42.

According to the exemplary embodiments shown in the FIGURES, the flange 52 and the flange 56 extend out (i.e., away) from the chamber 50. According to another exemplary embodiment, the flange 52 and the flange 56 may extend into the chamber 50. According to yet another exemplary embodiment, the flange 52 and the flange 56 may be centered on the outside wall of the structure 42 (i.e., the flange 52 and the flange 56 are inline with the outside wall of the structure 42).

According to an exemplary embodiment, the wall thickness of the structure 42 (including the wall thickness of the groove 58) is 3 mm, but may be greater or smaller according to other exemplary embodiments. According to an exemplary embodiment, the thickness of the protrusion 54 is approximately 1 mm, but may be greater or smaller according to other exemplary embodiments. According to an exemplary embodiment, the width of the groove 58 is also approximately 1 mm, but may be greater or smaller according to other exemplary embodiments. According to one exemplary embodiment, the protrusion 54 may be slightly wider than the opening of the groove 58 to provide an interference fit when the two portions of the structure 42 are coupled together (see, e.g., FIG. 9).

According to an exemplary embodiment, the protrusion 54 extends out from the flange 52 by approximately 2 mm, but may extend further or shorter according to other exemplary embodiments. Likewise, the depth of the groove 58 is approximately 2 mm, but may be greater or smaller according to other exemplary embodiments.

According to various exemplary embodiments, the protrusion 54 and/or groove 58 may be shaped and/or sized differently than that shown in FIGS. 8-10 and described above. For example, the protrusion 54 may have a square, trapezoidal, tapered, or other cross-sectional shape (the groove 58 may or may not have a corresponding complimentary shape). Additionally, the end of the protrusion 54 may be square (e.g., as shown in FIGS. 8-10), conical, pointed, or otherwise shaped. The cross-sectional shape of the groove 58 may also be different than that shown in FIGS. 8-10. For example, the groove 58 may be U-shaped, horseshoe-shaped, or have another cross-sectional shape (the protrusion 54 may or may not have a corresponding complimentary shape).

According to one exemplary embodiment, the two portions of the structure 42 are vibration welded together. According to one exemplary embodiment, the vibration welding may occur for approximately two seconds, but may occur for a greater or lesser time according to other exemplary embodiments. According to another exemplary embodiment, the two portions of the structure 42 oscillate with respect to one another a total of approximately 1.5 mm (e.g., 0.75 mm in either direction) during vibration welding, but may oscillate a greater or lesser distance according to other exemplary embodiments.

According to an exemplary embodiment, the vibration welding causes localized melting of the material of the structure 42 (i.e., the protrusion 54 and/or the walls of the groove 58). According to another exemplary embodiment, the shape of the groove 58 (e.g., horseshoe-shape, U-shape, etc.) seals in flash (e.g., debris) caused by the melting of material of the structure 42 during vibration welding, such that there is no flash that may contaminate the battery module 22.

According to another exemplary embodiment, the protrusion 54 may be smaller than the groove 58 to provide clearance between the protrusion 54 and the groove 58 (see, e.g., FIG. 10 showing a protrusion 54A that is slightly smaller than groove 58A). According to one exemplary embodiment, a caulk-like or sealing material 60 (e.g., silicone) may be provided between the two portions of the structure 42, including in the space created by the clearance between the protrusion 54A and the groove 58A, to form a living seal that stays pliable/flexible when cured. Having a living seal substantially ensures that no air gaps are formed (e.g., produced, created, etc.) when the structure 42 (and the battery module 22) is subjected to vibration (e.g., vibration caused by the vehicle traveling on a road) in order to keep the chamber 50 sealed.

According to one exemplary embodiment, the sealing material is provided on both the protrusion 54 and the groove 58A. According to another exemplary embodiment, the silicone material is provided only in the groove 58A. According to another exemplary embodiment, the silicone material is provided only on the protrusion 54A.

According to another exemplary embodiment, the two portions of the structure 42 may be coupled together with fasteners (e.g., with, screws, bolts, rivets, clamps, etc.), with or without the sealing material 60. According to another exemplary embodiment, the two portions of the structure 42 may be coupled together with an adhesive or glue in replace of the sealing material 60 (and with or without fasteners).

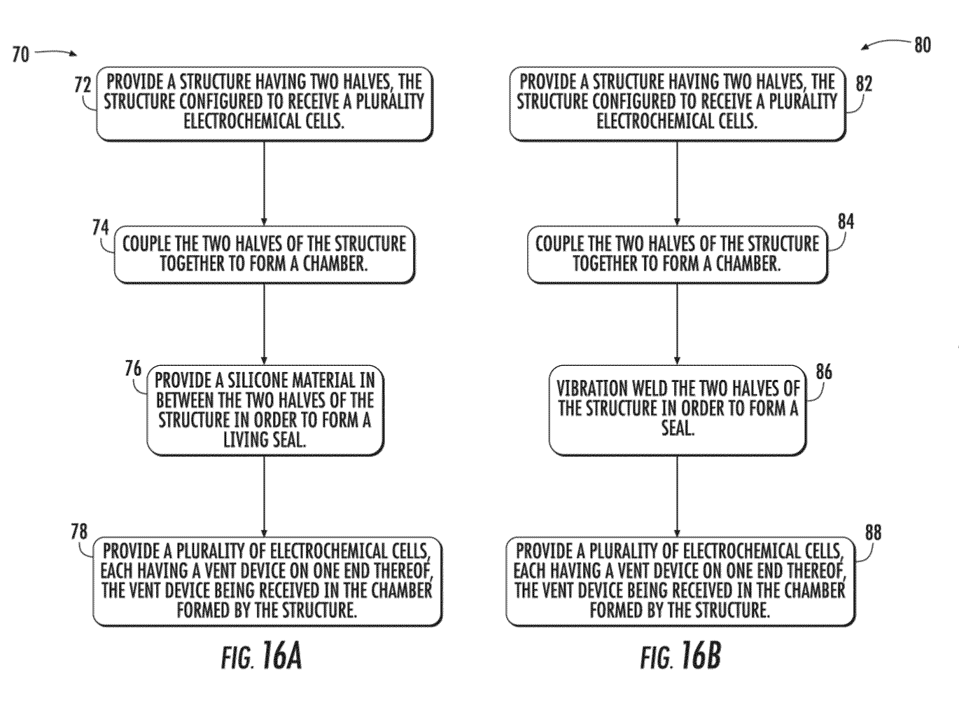

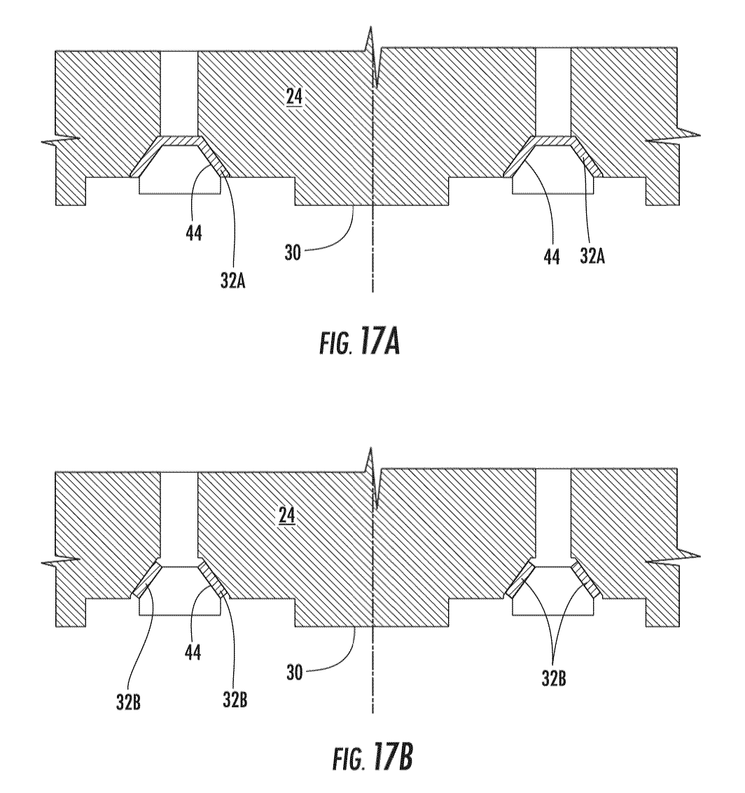

Referring now to FIG. 16A, a flow chart 70 describing a method of providing a battery module having a sealed chamber is shown according to an exemplary embodiment. A first step 72 includes providing a structure having two members or portions, the structure configured to receive a plurality electrochemical cells. A second step 74 includes coupling the two members or portions of the structure together to form a chamber. A third step 76 includes providing a silicone material in between the outer edges of the two members or portions of the structure in order to form a living seal. A fourth step 78 includes providing a plurality of electrochemical cells to form a battery module, each cell having a vent on one end thereof, the vent being received in the chamber formed by the structure.

Referring now to FIG. 16B, a flow chart 80 describing a method of providing a battery module having a sealed chamber is shown according to another exemplary embodiment. A first step 82 includes providing a structure having two members or portions, the structure configured to receive a plurality electrochemical cells. A second step 84 includes coupling the two members or portions of the structure together to form a chamber. A third step 86 includes welding (e.g., vibration welding) the two members or portions of the structure together to form a seal. A fourth step 88 includes providing a plurality of electrochemical cells to form a battery module, each cell having a vent on one end thereof, the vent being received in the chamber formed by the structure.

According to an exemplary embodiment, a battery module includes a plurality of electrochemical cells provided in a tray or structure. Each of the plurality of cells includes a vent feature on one end thereof. The vent feature of the cell is located in a chamber formed by the tray. The chamber is configured to contain any gases and/or effluent that is vented from the cells via the vent feature. The chamber is formed by two halves of the tray being coupled together to form a seal. The seal is used to prevent any gases and/or effluent from escaping the chamber. The seal may be formed by vibration welding the ends of the two halves of the tray together or by applying a silicone material in between the ends of the two halves of the tray. The end of one half of the tray may include a protrusion and the end of the other half of the tray may include a slot configured to receive the protrusion.

According to another exemplary embodiment, a battery module includes a plurality of electrochemical cells provided in a tray or housing. The electrochemical cells include a vent device on one end thereof. The vent device is provided in the housing such that when the vent device deploys, gases and/or effluent are discharged into a chamber formed by two halves of the housing. An edge of the first half of the housing may include a rib or protrusion that is received in a slot or a groove in an edge of the second half of the housing. According to one exemplary embodiment, the rib may be larger than the groove to provide an interference fit. According to another exemplary embodiment, the rib may be smaller than the groove to provide clearance to provide a silicone material between the two halves of the housing to form a living seal. According to another exemplary embodiment, the two halves of the housing are vibration welded together.

According to another exemplary embodiment, a battery module includes a plurality of electrochemical cells each having a vent device on one end thereof. The battery module also includes a structure configured to receive the plurality of electrochemical cells, the vent device of each of the cells being received in a chamber formed by the structure. The structure includes a first portion having a protrusion on an edge of the first portion. The structure includes a second portion having a groove on an edge of the second portion, the groove configured to receive the protrusion of the first portion. According to an exemplary embodiment, the first portion is coupled to the second portion by vibration welding. According to an exemplary embodiment, the rib is larger than the groove to provide for an interference fit. According to another exemplary embodiment, the rib is smaller than the groove to provide clearance for a material to be provided in between the rib and the groove in order to form a living seal to couple the first portion with the second portion.

According to another exemplary embodiment, a method of sealing two halves of a housing to form a chamber includes providing a plurality of electrochemical cells each having a vent device on one end thereof. The method also includes providing a structure configured to receive the plurality electrochemical cells, the vent device of each of the cells being received in a chamber formed by the structure. The structure includes a first portion having a protrusion on an edge of the first portion. The structure includes a second portion having a groove on an edge of the second portion, the groove configured to receive the protrusion of the first portion. According to an exemplary embodiment, the method further includes coupling the first portion to the second portion (e.g., by vibration welding). According to an exemplary embodiment, the rib is larger than the groove to provide for an interference fit. According to another exemplary embodiment, the rib is smaller than the groove to provide clearance for a material to be provided in between the rib and the groove in order to form a living seal to couple the first portion with the second portion.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the battery module as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A battery module comprising:
a plurality of electrochemical cells each comprising a vent at one end of the cell configured to allow gas to escape from within the cell; and
a structure configured to receive the plurality of electrochemical cells so that the vent of each electrochemical cell is in fluid communication with a chamber within the structure, the structure comprising a first portion comprising a protrusion provided along an outer edge thereof and a second portion comprising a groove provided along an outer edge thereof, wherein the groove is configured to receive the protrusion of the first portion to seal gas released from any of the electrochemical cells within the chamber.

2. The battery module of claim 1, wherein the plurality of electrochemical cells are provided in the first portion of the structure.

3. The battery module of claim 1, wherein plurality of electrochemical cells are provided in both the first portion and the second portion of the structure.

4. The battery module of claim 1, wherein the structure comprises sockets to receive the plurality of electrochemical cells.

5. The battery module of claim 4, wherein each of the sockets of the structure comprise a seal to seal each of the vents of the electrochemical cells within the chamber.

6. The battery module of claim 4, further comprising a seal configured to seal each of the vents of the electrochemical cells within the chamber.

7. The battery module of claim 1, wherein the protrusion and the groove are sized to have an interference fit.

8. The battery module of claim 1, wherein the protrusion is smaller than the groove to allow for a sealing material to be provided between the protrusion and the groove.

9. The battery module of claim 8, wherein the sealing material comprises silicone.

10. A battery module comprising:
a plurality of electrochemical cells, each cell comprising a vent at one end thereof, each vent configured to allow gas from within the cell to exit the cell; and
a structure configured to receive the plurality of electrochemical cells so that the vent of each electrochemical cell is provided within a chamber defined by the structure, the structure comprising a first portion comprising a projection provided along an outer edge thereof and a second portion comprising a groove provided along an outer edge thereof, wherein the groove is configured to receive the projection of the first portion to seal the chamber such that gas released from any of the electrochemical cells remains within the chamber.

11. The battery module of claim 10, wherein the plurality of electrochemical cells are provided in the first portion of the structure.

12. The battery module of claim 10, wherein plurality of electrochemical cells are provided in both the first portion and the second portion of the structure.

13. The battery module of claim 10, wherein the structure comprises sockets to receive the plurality of electrochemical cells.

14. The battery module of claim 10, wherein the projection and the groove are sized to have an interference fit.

15. A method of producing a battery module having a sealed chamber comprising:
providing a plurality electrochemical cells, each of the electrochemical cells comprising a vent at an end thereof;
providing a structure configured to receive the ends of each of the electrochemical cells, the structure comprising a first portion comprising a protrusion located along an outer edge thereof and a second portion comprising a groove located along an outer edge thereof, the groove configured to receive the protrusion of the first portion; and
coupling the first and second portions of the structure together to form a sealed chamber.

16. The method of claim 15, wherein the vent of each of the plurality of electrochemical cells is in fluid communication with the chamber.

17. The method of claim 15, wherein the first and second portions are vibration welded together.

18. The method of claim 15, wherein the protrusion of the first portion and the groove of the second portion are configured for an interference fit.

19. The method of claim 15, wherein the protrusion of the first portion is smaller than the groove of the second portion, the method further comprising providing a sealing material between the protrusion and the groove to form a living seal.

20. The method of claim 19, wherein the sealing material comprises silicone.
